(19) United States
(12) Patent Application Publication
(10) Pub. No.: US 2007/0109417 A1
(43) Pub. Date: May 17, 2007

(54) Methods, devices and computer program products for remote control of an image capturing device

(76) Inventors: Per Hyttfors, Lund (SE); Jens Gulin, Lund (SE); Karl Soderstrom, Lund (SE)

Correspondence Address: MYERS BIGEL SIBLEY & SAJOVEC, P.A., P.O. BOX 37428, RALEIGH, NC, 27627, US

(21) Appl. No.: 11/280,920

(22) Filed: Nov. 16, 2005

(51) Int. Cl. H04N 5/232

(52) U.S. Cl. 348/211.99

(57) ABSTRACT

Methods of controlling a remotely located image capturing device from a portable communication device include receiving man-machine interface (MMI) data at the portable communication device from the image capturing device. The MMI data may include a set of screen data related to a screen intended for presentation on a display of the portable communication device, and the set of screen data may include a selectable command related to the screen. The methods further include receiving media data from the image capturing device, presenting the media data at the portable communication device together with the at least one set of screen data, selecting the command, and sending the selected command to the image capturing device. Also disclosed are a portable communication device, an image capturing device, and methods of controlling an image capturing device.

### FIELD OF THE INVENTION

The present invention relates to the field of controlling an image capturing device. In particular, the present invention relates to methods and computer program products for controlling a remotely located image capturing device from a portable communication device, as well as to portable communication devices configured to remotely control image capturing devices, and to image capturing devices capable of being remotely controlled by portable electronic devices.

### BACKGROUND

Cameras, including digital still cameras, video cameras and other image capturing devices have become smaller and smaller, and have recently been integrated into portable electronic devices such as mobile telephones, personal digital assistants (PDAs) and the like. Accordingly, it has become possible to capture an image in a portable electronic device, and to transmit images captured from one device to another.

However, in such a scenario, the recipient of the image may have little or no control over the capture or transmission of the image. It would therefore be of interest to be able to control an image capturing device, such as a camera or a camcorder, from a portable communication device, such as a mobile telephone.

In this regard, U.S. Pat. No. 6,400,903 describes a remote camera relay method and apparatus for remotely operating a self-contained, unattended digital camera over a communications link. Commands are sent to the camera and images received from the camera. It is also possible to control different functions relating to the camera such as zoom, tilt, pan, position on a tripod etc.

Another potential solution is described in European Patent No. EP 1 429 556, which describes a modular camera, having two modules that may communicate with each other using a Bluetooth connection.

However, it may be desirable to provide more flexible control of image capturing devices from a portable communication device, such as a mobile telephone, such that it may be possible to control a range of image capturing devices.

### SUMMARY

Some embodiments of the invention may provide more flexible control of an image capturing device from a portable electronic device. According to some embodiments of the invention, man-machine interface (MMI) information may be transferred from an image capturing device to a portable communication device for allowing the portable communication device to issue commands to the image capturing device. Accordingly, some embodiments of the invention may provide methods of controlling a remotely located image capturing device from a portable communication device, which enables flexible control of the image capturing device.

Some embodiments of the present invention provide methods of controlling a remotely located image capturing device from a portable communication device, the methods including receiving MMI data at the portable communication device from the image capturing device. The MMI data may include at least one set of screen data related to a screen intended for presentation on a display of the portable communication device, and the at least one set of screen data may include at least one selectable command related to the screen. The method further includes receiving media data from the image capturing device, presenting the media data at the portable communication device together with the at least one set of screen data, selecting the command, and sending the selected command to the image capturing device.

Some methods may further include receiving at least one image captured by the image capturing device, and storing the image in the portable communication device.

The at least one set of screen data may include format information specifying a format in which the selectable command may be to be transferred, and/or a pointer to a further screen.

Some methods may further include selecting a pointer associated with a screen other than the active screen, and setting the screen associated with the selected pointer as an active screen.

The command may include a command to browse images stored in the image capturing device, and the methods may further include receiving at least one image stored in the image capturing device in response to the command. The command may further include a control command for adjusting the image capturing device.

Some methods may further include receiving a plurality of sets of data relating to a plurality of respective screens, storing the plurality of sets of data in the portable communication device, and setting one of the screens as an active screen.

The at least one set of screen data relating to a screen may be received by itself and may include a pointer to a further screen, and the methods may further include selecting the pointer, transmitting the pointer to the image capturing device, and receiving a set of screen data associated with the pointer.

Some methods may further include associating the command with a user input unit of the portable communication device, and presenting the command using a display of the portable communication device.

Some methods may further include combining captured image data received from the image capturing device with image data from a source other than the image capturing device.

A portable communication device according to some embodiments of the invention includes an interface unit configured to receive MMI data and associated media data from an image capturing device. The MMI data may include at least one set of screen data related to a media capturing screen intended for presentation on a display of the portable communication device and including at least one selectable command related to the screen. The device further includes a local store and a control unit configured to select the command, and to cause the interface unit to send the command to the image capturing device.

The command may include an image capturing command and the interface unit may be further configured to receive at least one image captured by the image capturing device and to store the at least one image in the local store.

The command may include a command to browse images stored in the image capturing device, and the interface unit may be further configured to receive at least one image stored in the image capturing device when the command may be selected.

The command may include a control command for adjusting the image capturing device.

The interface unit may be configured to receive a plurality of sets of data relating to screens, to store the plurality of sets of data in the local store, and to set one of the screens as an active screen.

The interface unit may be configured to receive one set of data relating to a screen by itself, and the control unit may be further configured to select a pointer in the set of data to a further selectable screen and to cause the interface unit to transmit the pointer to the image capturing device.

A portable communication device may further include a number of user input units and a display, and the control unit may be further configured to associate the command with at least one of the user input units, and to present the command on the display.

The control unit may be further configured to combine captured image data received from the image capturing device with image data from a source other than the image capturing device.

In particular embodiments, the portable communication device may include a mobile telephone.

A computer program product for controlling a remotely located image capturing device from a portable communication device includes a computer readable storage medium having computer readable program code embodied in the medium. The computer readable program code may include computer readable program code configured to receive MMI data and associated media data from the image capturing device including at least one set of screen data related to a screen intended for presentation on a display of the portable communication device and including a selectable command related to the screen, computer readable program code configured to select the command, and computer readable program code configured to cause the command to be sent to the image capturing device.

The computer program product may further include computer readable program code configured to receive at least one image captured by the image capturing device, and computer readable program code configured to store the at least one image in the portable communication device.

Methods of operating an image capturing device to enable the image capturing device to be remotely controlled by a portable electronic device according to some embodiments of the invention include sending MMI data from the image capturing device to the portable communication device. The MMI data may include at least one set of screen data related to at least one screen intended for presentation on a display of the portable communication device. The MMI data may further include selectable commands related to the screen, format information specifying the format in which the commands are to be transferred, and/or a pointer to a further selectable screen, one of the at least one screens may be a media capturing screen. The methods may further include sending media data intended to be presented together with the MMI data from the image capturing device to the portable communication device, and receiving a command from the portable communication device.

The MMI data may include an image capturing command, and the method may further include sending at least one image captured by the image capturing device to the portable electronic device in response to receiving the image capturing command from the portable communication device.

The MMI data may include a command to browse images stored in the image capturing device, and the method may further include sending at least one image stored in the image capturing device to the portable electronic device in response to receiving the command to browse images from the portable communication device.

The MMI data may include a control command for adjusting the image capturing device, and the method may further include adjusting the image capturing device in accordance with the control command in response to receiving the control command from the portable communication device.

Some embodiments of the invention provide an image capturing device including an interface unit configured to send MMI data and associated media data from the image capturing device to the portable communication device, and a control unit configured to cause the interface unit to send at least one image captured by the image capturing device in response to a command from the portable communication device.

The control unit may be further configured to cause at least one image stored in the image capturing device to be sent to the portable electronic device in response to a command to browse images received from the portable electronic device.

The control unit may be further configured to adjust the image capturing device according to a control command for adjusting the image capturing device.

A computer program product for enabling a portable communication device to control a remotely located image capturing device according to some embodiments of the invention includes a computer readable storage medium having computer readable program code embodied in the medium. The computer readable program code may include computer readable program code configured to send MMI data from the image capturing device to the portable communication device, computer readable program code configured to send media data intended to be presented together with the MMI data from the image capturing device to the portable communication device, and computer readable program code configured to receiving a command from the portable communication device.

Some embodiments of the invention may be used with any image capturing device that has the possibility to be controlled. Some embodiments of the invention may not depend on having special software pre-installed or provided elsewhere which is dedicated to the special image capturing device in question. In this way a user may have great freedom in the selection of an capturing device equipment that is to be controlled. It may furthermore be possible to change control from one image capturing device to another, and a portable communication device may also allow itself to be controlled by other portable communication devices. There may thus be considerable flexibility in how control may be provided. It may for instance be possible to use new functions that are provided in an image capturing device. Since MMI information may be sent from the image capturing device to the portable communication device, the user of the portable communication device may furthermore get the feeling that he is directly using the image capturing device, although it is remotely located.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a schematic illustration of a mobile telephone communicating with a camera using a communication link in accordance with some embodiments of the invention;

FIG. 2 is a schematic block diagram of a mobile telephone and a camera according to some embodiments of the invention;

FIG. 3 illustrates a number of sets of screen data that may be sent from a camera to a mobile telephone according to some embodiments of the invention;

FIG. 4 illustrates an exchange of data and/or instructions between a mobile telephone and a camera according to some embodiments of the invention;

FIG. 5 is a flow chart illustrating operations of a mobile telephone according to some embodiments of the present invention;

FIG. 6 is a flow chart illustrating operations of a camera according to some embodiments of the present invention; and

FIG. 7 schematically shows a computer program product in the form of a CD-ROM disc including thereon computer program code for carrying out operations according to some embodiments of the invention.

### DETAILED DESCRIPTION OF EMBODIMENTS OF THE INVENTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Some embodiments of the present invention provide a portable communication device configured to communicate with a image capturing device via a connection.

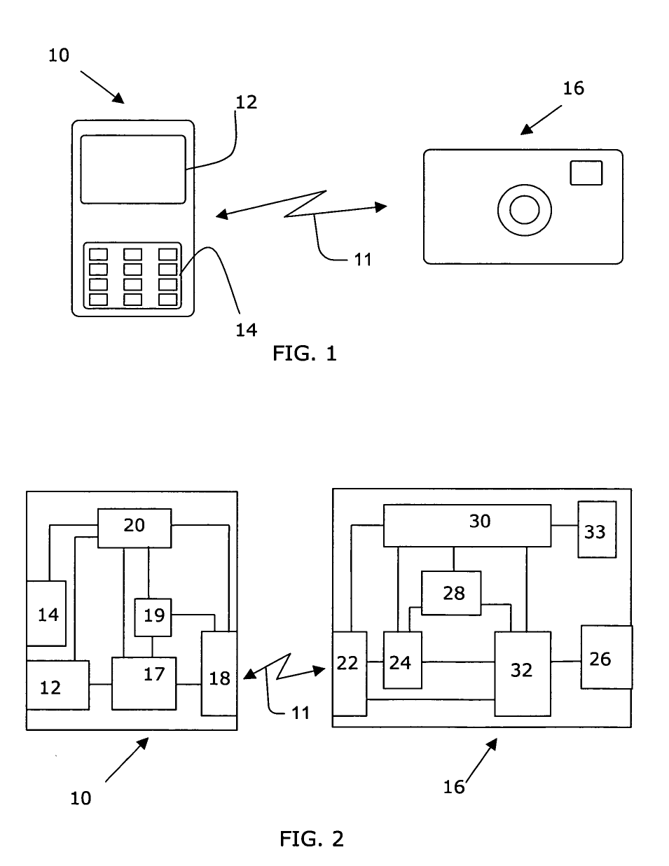

Referring to the embodiments of FIG. 1, a portable communication device 10, in the form of a mobile telephone, communicates with an image capturing device 16, in the form of a camera, via a communication link 11, which may be, for example, a Bluetooth ad hoc wireless RF network connection. The portable communication device 10 may be used to remotely control the image capturing device 16. In order to allow a user to control the image capturing device 16, the portable electronic device 10 may include a display 12 and a set of user input units in the form of a number of keys on a keypad 14.

A mobile telephone is just one example of a portable electronic device that may be provided with an ability to communicate with an image capturing device according to some embodiments of the invention. The present invention is not limited to this type of device, but can be applied to other types of portable communication devices, such as for instance smartphones, communicators, and/or other portable electronic devices such as laptop computers, palmtop computers and/or electronic organizers. However, for convenience, the portable communication device 10 may be referred to herein simply as a telephone 10. Likewise, the image capturing device 16 is not limited to a camera, but can also be a camcorder, or even another portable communication device that includes functionality for capturing either still images and/or video images. However, for convenience, the image capturing device 16 may be referred to herein simply as the camera 16. Naturally it is also possible that the camera 16 may be capable of capturing sound, either separately from or along with still and/or video images.

FIG. 2 is a schematic block diagram illustrating some components of a telephone 10 and a camera 16. The portable electronic device 10 includes a first interface unit 18 connected to a phone control unit 20, a local phone store 19 and a video decoding unit 17. The phone control unit 20 is furthermore connected to the display 12, the keypad 14, the local phone store 19 and the video decoding unit 17. The first interface unit 18 may include a Bluetooth communication unit. The video decoding unit 17 is furthermore connected to the local phone store 19 and the display 12. The camera 16 includes a lens 26 connected to a digital image receiving unit 32, which converts a projected image into a digital picture. The image receiving unit 32 may include a CCD unit. The digital image receiving unit 32 is connected to an image store 28, to a camera control unit 30, to a video streaming unit 24 and to a second interface unit 22. The video streaming unit 24 is furthermore connected to the camera control unit 30, the image store 28 and the second interface unit 22. The camera control unit 30 is also connected to the image store 28 and to an image capturing control actuator 33, which may be a button. The second interface unit 22 may also include a Bluetooth communication unit that communicates with the first interface unit 18 of the telephone 10 via the communication link 11.

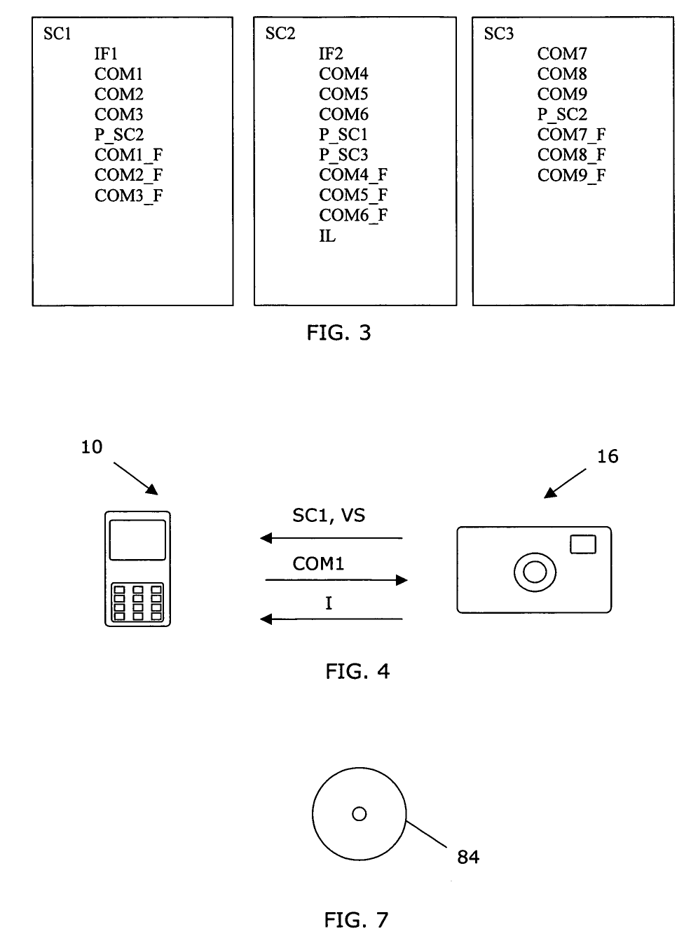

FIG. 3 shows Man-Machine Interface (MMI) data in the form of three sets of screen data SC1, SC2 and SC3 that may be provided by the camera 16 to the telephone 10. Each set of screen data is related to a screen that may be provided on a display of the camera 10, and may include commands that are shown and that can be activated. In a first set of screen data SC1 for a first screen, these are commands COM1, COM2 and COM3; in a second set of screen data SC2 these are commands COM4, COM5 and COM6, while in a third set of screen data SC3 these are commands COM7, COM8 and COM9. It should be realized that the number of commands shown are only exemplary, and more or fewer commands may be provided in each set of screen data. There may be, however, at least one command in each set.

The first set of screen data SC1 includes a pointer P_SC2 to the second set of screen data SC2. The second set of screen data SC2 includes a pointer P_SC1 to the first set of screen data SC and a pointer P_SC3 to the third set of screen data SC3, while the third set of screen data SC3 includes a pointer P_SC2 to the second set of screen data. It should be realized that the first and third screens SC1, SC3 may include pointers to each other, and that it is possible to provide more sets of screen data for further screens, in which case each set may include further pointers. It is furthermore possible that only one screen may be provided by the camera, in which case no screen pointers may be included. The sets of screen data may furthermore include format information regarding the format in which the commands are to be transferred. Thus the first set SC1 includes format information COM1_F for the first command, format information COM2_F for the second command and format information COM3_F for the third command. The second and third sets include similar format information for their commands. The second set of screen information also includes an image list IL of previously captured images. In the first and second sets of screen data SC1 and SC2, there is furthermore an image frame identifier IF1, IF2, each defining an area where images are to be displayed on a display. The third set of screen data SC3 could also include such a frame identifier. Each set of screen data may be provided as an XML-file. However it should be realized that XML is only one way of implementing a set of screen data, and that screen data could be organized in many different formats, including standardized and/or non-standardized formats. However, it will be appreciated that using standardized formats may provide more flexibility for interoperability of different kinds of portable electronic devices and/or image capturing devices.

FIG. 4 schematically shows communications between the telephone 10 and the camera 16 according to some embodiments of the invention. As illustrated therein, MMI data including a first set of screen data SC1 and a video stream VS is sent from the camera 16 to the telephone 10. Thereafter, a command COM1 is sent from the telephone 10 to the camera 16 followed by the transmission of an image I from the camera 16 to the telephone 10.

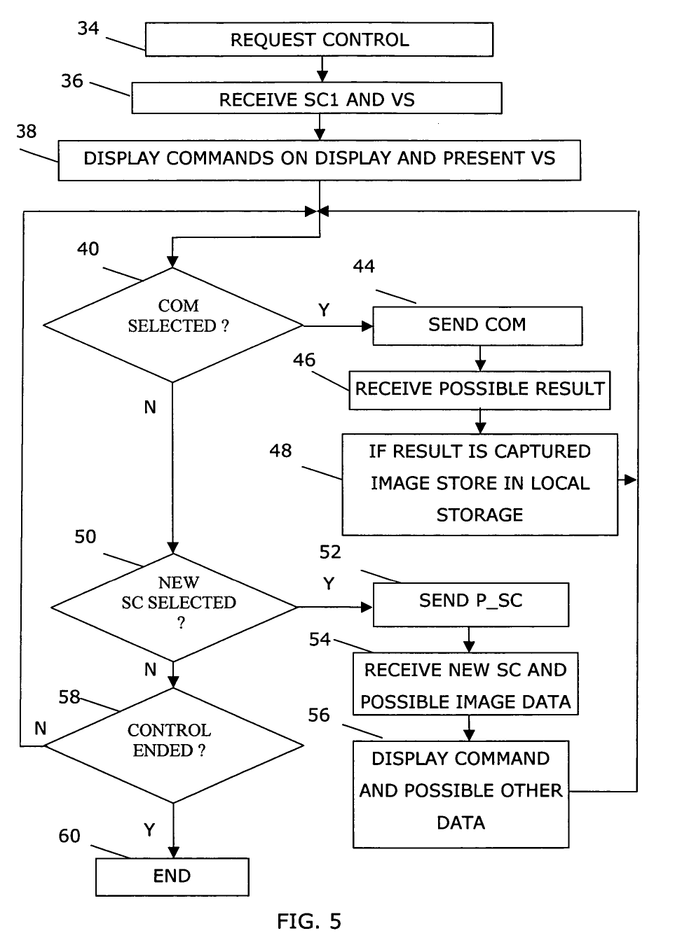

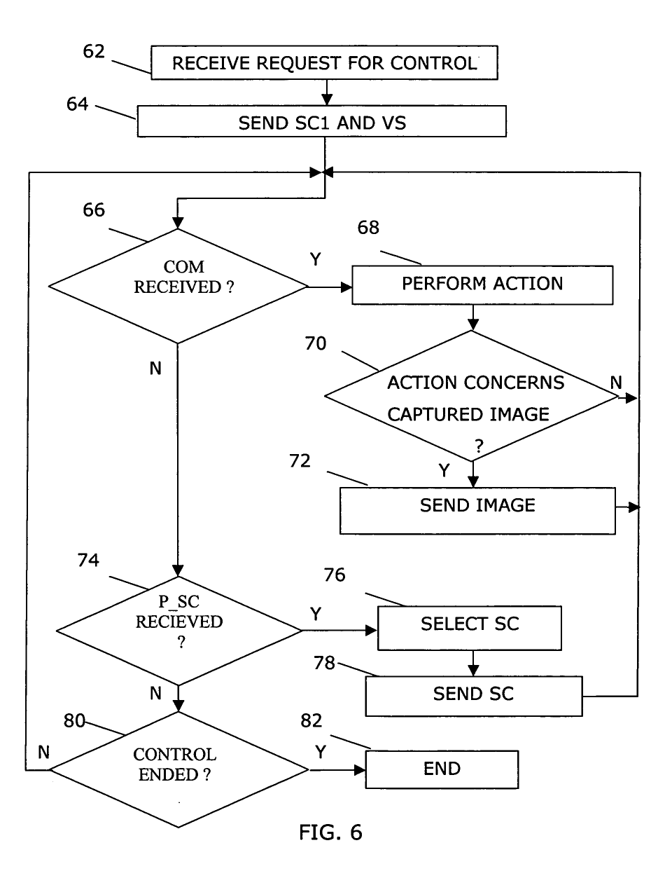

Operations according to some embodiments of the invention will now be described with reference being made to FIGS. 1-4 as well as to FIG. 5, which is a flow chart of operations that may be performed in the telephone 10, and to FIG. 6, which is a flow chart of operations that may performed in the camera 16.

In its normal mode of operation, the camera may be a separate device, which performs normal camera functions. In these functions images captured by the lens 26 are provided to the image receiving unit 32. The images provided there may then be captured and stored in the image store 28. This may be done according to some embodiments of the invention, for example, by the user of the camera 16 activating the capturing control actuator 33. However, the camera may also be controlled by the telephone 10, which will now be described.

Operations illustrated in FIG. 5 initiate with the telephone 10 taking control of the camera 16. This may be done by the phone control unit 20 causing the first interface unit 18 to send a request for control to the camera (block 34). The camera 16 receives this request (block 62) at the second interface unit 22 and forwards the request to the camera control unit 30. The camera control unit 30 may perform a check to see if control should be surrendered or not, either by prompting the user of the camera 16, for instance via a display, or through checking the identity of the phone 10 in relation to identities that are allowed to take over control of the camera 16. It is also possible to perform both of these checks.

Assuming that the telephone 10 is granted control, the camera control unit 30 then fetches a first set of screen data SC1, which is stored in the image store 28, provides it to the interface unit 22, and causes the interface unit 22 to send the first set of screen data SC1 to the telephone 10. The first set of screen data SC1 may be associated with normal camera or default image capturing functions. In order to allow a user of the phone 10 to take photos using the camera 16, the viewfinder image of the camera 16 may be provided to the telephone 10. Therefore, the control unit 30 may cause the image receiving unit 32 to forward images it registers to the video streaming unit 24.

The video streaming unit 24 creates a video stream VS and may format the video stream, for instance into an MPEG video stream. The control unit 30 furthermore causes the video streaming unit 24 to provide the stream VS to the interface unit 22, and the interface unit 22 to send the video stream VS to the telephone 10. In this way, the first set of screen data SC1 and media data in the form of the video stream VS are sent along with the MMI data to the telephone 10 (block 64). Thereafter, the camera 16 awaits the reception of instructions from the telephone 10.

The first interface unit 18 receives the first set of screen data SC1 and the video stream VS (block 36), and forwards the first set of screen data SC1 to the phone control unit 20 and the video stream to the video decoding unit 17, which may include an MPEG decoder. The control unit 20 first looks at the image frame identifier IF1 and determines a window on the display 12 to be used for displaying images, and, in this case, the video images of the video stream VS. The control unit 20 then looks at the commands COM1, COM2 and COM3 and determines what keys on the keypad 14 are to be associated with the commands, and also where and how to display information regarding the commands on the display 12. For example, commands may be located on the screen 12 in proximity to keys which activate the commands. In other embodiments, the screen 12 or regions thereof may include a touch screen, in which case the commands may be presented on the screen 12 as pressable button images on the touchscreen.

The control unit 20 also determines a key to be associated with the pointer P_SC2 to a next set of screen data SC2, if any. As an alternative, the camera may specify where commands and/or pointers are to be displayed, where images are to be displayed, and even what keys are to be used in the first set of screen data SC1 so that the phone control unit 20 only needs to implement it directly. The phone control unit 20 thereafter sets the screen defined by the set of screen data SC1 as an active screen, activates the mapping of commands and pointers to keys, displays them on the display 12 and causes the video decoding unit 17 to provide the video stream VS to the display at the specified location. The control unit 20 thus makes sure that the commands are displayed and the video stream VS is presented on the display 12 (block 38).

When the phone control unit 20 has done this, it may await user inputs via the specified keys on the keypad 16. When the user depresses a key, the control unit 20 selects an instruction corresponding to the depressed key. If a command has been selected (block 40), the control unit 20 causes the first interface unit 18 to send the command using the specified format to the camera 16.

If the user input corresponds to the selection of a command, which in the first screen may be a command COM1 (for example, a command to capture an image, a command to adjust the camera, like zoom, tilt, pan or some other command like flash control), the command COM is sent to the camera (block 44). The second interface unit 22 receives the instruction from the telephone 10 and forwards it to the camera control unit 30. If the instruction is a command COM (block 66), the control unit 30 causes the camera to perform the action corresponding to the command, which action may be, for example, the capturing of an image, or a command adjusting the camera such as the tilting or panning of the camera or a zoom command. If the action relates to a captured image (block 70), the control unit 30 causes the image to be sent to the telephone 10 (block 72). An image related to a command in the first set of screen data SC1 in the first screen is normally a newly captured image, which is stored in the image store 28. The control unit 30 would then retrieve the image from the image store 28 and send it via the interface unit 22 to the telephone 10, or make the image receiving unit 32 directly forward the image to the interface unit 22 (block 48). In some other screens, it might be an earlier captured image, as in the second screen which provides a browsing screen, where a command may be a command to browse images stored in the image store 28. In this case, the control unit 30 would cause a previously captured image to be retrieved from the image store 28. Thereafter, the camera 16 awaits further instructions. It should be realized that the camera may normally continue to present the view-finder, i.e. the camera 16 may continue to send the video stream VS to the telephone 10 after an image I has been sent, in order to facilitate the capturing of further images. This may be done as long as the first screen is an active screen. However, in some embodiments, the camera 16 may cease sending the view-finder video stream to the telephone 10, for example to conserve battery power, until instructed by the telephone 10 to resume sending the view-finder video stream.

The telephone 10 then receives the possible results of the actions performed via the first interface unit 18 (block 48), which results are forwarded to the phone control unit 26. If the result is a captured image that is received, either a previously stored or a newly captured image, which is shown in FIG. 4 as the reception of an image I, the image I is stored in the local store 19 under the control of the control unit 20. The image may also be presented on the display 12. Thereafter the telephone 10 awaits user inputs (blocks 40 and 50).

In case the user inputs did not correspond to the selection of a command (block 40), the control unit 20 determines if the instruction was a selection of a new screen (block 50). If the user had used a key corresponding to the selection of a new screen, the control unit 20 selects and fetches a pointer to the set of screen data of that screen, which in this case would be P_SC2, and sends it to the camera 16 via the interface unit 18 (block 52). Thereafter, the camera awaits further instructions (blocks 66 and 74).

When the camera control unit 30 sees that a received instruction is not a command (block 66), but a screen pointer P_SC2 (block 74), it may then disrupt the sending of the video stream, if there was such a stream. Thereafter, the corresponding set of screen data SC2 is generated by the control unit 30 and sent to the telephone 10 via the interface unit 22 (block 78).

The first interface unit 18 of the telephone 10 receives the second set of screen data SC2 (block 54) that may be accompanied by image data, such as for instance a previously saved image, and forwards the set of screen data SC2 to the phone control unit 20. The control unit 20 proceeds to map commands and pointers to keys on the keypad 14 and presents them in the same way as for the first screen (block 56). The control unit then makes this screen an active screen. If the screen is the second screen, which is a browsing screen outlining previously captured images, it may furthermore present the image list IL, so that the user 10 of the phone may know what images to select from. If an image is present, the control unit 20 causes an image handling unit, which may be combined with the video decoding unit 17, to present the image in an area defined by an image frame identifier IF2. In this screen, a user may therefore select older images to study. Accordingly, one of the commands may be a browsing command through which a user of the telephone 10 may browse old images stored in the camera 16. When a new screen has been selected, the telephone 10 therefore goes back and awaits the selection of a command (block 40), or the selection of another screen (block 50). In the same way, the camera 16 goes back and awaits the reception of a command (block 66), or the reception of a new screen pointer P_SC (block 74).

In FIG. 3 there is shown a third screen SC3 that may be selected. This screen is a setting screen, where different settings of the camera may be adjusted remotely, such as video, black and white, color, resolution, languages, etc. These commands, which may include commands like “get” a certain setting and/or “change” a certain setting, can be provided by the telephone 10 and/or the camera 16 in the same way as was described above for the first and second screens.

If no command is selected (block 40), and no new screen is selected (block 50), the phone control unit 20 determines if control is to be ended or not (block 58). If it is not, the telephone 10 awaits a command COM (block 40), or a new screen selection (block 50). If, however, control is to be ended (block 58), the telephone 10 ends control (block 60), which may be done by the phone control unit 20 causing the first interface unit 18 to send an end of control request to the camera 16.

In the same way, if the instructions the camera 16 receives are not a command (block 66) and not a screen pointer (block 74), the camera 16 determines if it is an end of control request (block 80). If it is, the camera 16 ends the control (block 82), and resumes its original mode of operation; if not, the camera 16 awaits further instructions.

Embodiments of the invention have been described above with respect to the capture, transmission, and display of still images from a remotely located image capturing device to a portable communication device. It should be realized, however, that embodiments of the invention may involve the capture, transmission and/or display of moving images such as video, and also to images and/or video signals combined with sound. In this case, the phone control unit may order the recording and storing of the transmitted video that is already provided for the view-finder. It is furthermore possible to send a video stream from the camera 16, particularly a stored video stream. It should furthermore be realized that in the case of video images, they may be accompanied by sound that has been captured using a microphone and suitably coded together with the video images. Sound may also be captured and transmitted separately by the remote device according to some embodiments of the invention, provide appropriate MMI instructions are provided to the remote device. Accordingly, media data could include still images and/or video images with and/or without sound, and/or sound alone.

The present invention may enable a number of interesting applications. For example, it may be possible for a phone to combine images and/or sound from another source with the images and/or sound from the camera. The other source could be the phone itself, if it has camera functionality, or could be a second camera or another phone having camera functionality. In this way 3D images and/or stereo sound may be created. It is also possible to combine images from more than two sources. The results of such combinations may furthermore be transmitted to a server or some other entity like a PC, for further handling there.

Some embodiments of the present invention may have a number of further advantages. For example, some embodiments of the invention may be used with any camera that has the possibility to be controlled. Some embodiments according to the invention may not require having special software pre-installed or provided elsewhere that is dedicated to the particular camera in question. In this way a user may have great freedom in the choice of camera equipment that is to be controlled. It is furthermore possible to change control from one camera to another, and/or a telephone may also allow itself to be controlled by other telephones. There is thus a considerable flexibility in how control may be provided. It is for instance possible to allow the use of new functions that are provided in a camera. Since MMI information may be sent from the camera to the telephone, the user of the telephone may furthermore get the feeling of directly using the camera, although it is remotely located.

There are a number of other variations, alterations and modifications that can be made to embodiments the present invention, apart from the ones already mentioned. It is possible that all sets of screen data may be sent together to the phone. In that case, they may advantageously be provided in the same XML-file. In this way the phone may store these sets of screen data and change screens by itself without involving the camera. It may then only send commands to the camera, perhaps together with a notification to the camera of which screen is active. It is furthermore possible that the phone may take control automatically without inputs from a user, through the use of dedicated control software. In this case, it may not be necessary to display the various types of information on the telephone display screen. Screen pointers may furthermore be provided in commands, or in relation to results of actions performed by commands. It might for instance be possible to delete all images stored in the camera in relation to the second screen. Then, there would be no images to browse, while the command might directly point at a new screen. It is furthermore possible that the camera might return a screen pointer on its own initiative after having performed an action related to a command. Another possible variation is that the phone may receive capability information, i.e. information about what functions/operations the camera is capable of performing. This information may then be provided in the form of text and/or icons that can also be displayed on the screen of the phone.

It should also be realized that Bluetooth is just an example of a mechanism allowing communication between the devices. The communication can be performed using other radio communication mechanisms such as a wireless LAN connection, a cellular communication connection, an infrared (IR) communication link and/or even cables. The advantage of using Bluetooth is that it allows communication with more than one other device at the same time and without involving a network.

The control units in the phone and the camera are normally provided in the form of one or more processors together with a program memory store containing program code for performing the functions of these control units. This program code can also be provided on a computer program product, like a CD ROM disc, a memory stick or another suitable data carrier, which performs the invention when being loaded into the device. One such medium is schematically shown in FIG. 7, which shows a CD ROM disc 84, on which the program code for the phone, the camera or both may be provided. The program code may furthermore be provided on an external server and downloaded from there into the camera and/or the phone.

As will be appreciated by one of skill in the art, the present invention may be embodied as a method, data processing system, and/or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer usable storage medium having computer usable program code embodied in the medium. Any suitable computer readable medium may be utilized including hard disks, CD ROMs, optical storage devices, a transmission media such as those supporting the Internet or an intranet, or magnetic storage devices.

The present invention is described below with reference to flowchart illustrations and/or block diagrams of methods, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

In the drawings and specification, there have been disclosed typical embodiments of the invention and, although specific terms are employed, they are used in a generic and descriptive sense only and not for purposes of limitation, the scope of the invention being set forth in the following claims.

That which is claimed is:

1. A method of controlling a remotely located image capturing device from a portable communication device, comprising:
receiving MMI data at the portable communication device from the image capturing device, the MMI data including at least one set of screen data related to a screen intended for presentation on a display of the portable communication device, the at least one set of screen data including at least one selectable command related to the screen;
receiving media data from the image capturing device;
presenting the media data at the portable communication device together with the at least one set of screen data;
selecting the command; and
sending the selected command to the image capturing device.

2. A method according to claim 1, further comprising:
receiving at least one image captured by the image capturing device; and
storing the image in the portable communication device.

3. A method according to claim 1, wherein the at least one set of screen data includes format information specifying a format in which the selectable command is to be transferred, and/or a pointer to a further screen.

4. A method according to claim 3, further comprising:
selecting a pointer associated with a screen other than the active screen; and
setting the screen associated with the selected pointer as an active screen.

5. A method according to claim 1, wherein the command comprises a command to browse images stored in the image capturing device, the method further comprising receiving at least one image stored in the image capturing device in response to the command.

6. A method according to claim 1, wherein the command comprises a control command for adjusting the image capturing device.

7. A method according to claim 1, further comprising:
receiving a plurality of sets of data relating to a plurality of respective screens;
storing the plurality of sets of data in the portable communication device; and
setting one of the screens as an active screen.

8. A method according to claim 1, wherein the at least one set of screen data related to a screen is received by itself and includes a pointer to a further screen, the method further comprising:
selecting the pointer;
transmitting the pointer to the image capturing device; and
receiving a set of screen data associated with the pointer.

9. A method according to claim 1, further comprising:
associating the command with a user input unit of the portable communication device; and
presenting the command using a display of the portable communication device.

10. A method according to claim 1, further comprising:
combining captured image data received from the image capturing device with image data from a source other than the image capturing device.

11. A portable communication device, comprising:
an interface unit configured to receive MMI data and associated media data from an image capturing device, the MMI data including at least one set of screen data related to a media capturing screen intended for presentation on a display of the portable communication device and including at least one selectable command related to the screen;
a local store, and
a control unit configured to select the command, and to cause the interface unit to send the command to the image capturing device.

12. A portable communication device according to claim 11, wherein the command comprises an image capturing command and the interface unit is further configured to receive at least one image captured by the image capturing device and to store the at least one image in the local store.

13. A portable communication device according to claim 11, wherein the command comprises a command to browse images stored in the image capturing device, wherein the interface unit is further configured to receive at least one image stored in the image capturing device when the command is selected.

14. A portable communication device according to claim 11, wherein the command comprises a control command for adjusting the image capturing device.

15. A portable communication device according to claim 11, wherein the interface unit is configured to receive a plurality of sets of data relating to screens, to store the plurality of sets of data in the local store, and to set one of the screens as an active screen.

16. A portable communication device according to claim 11, wherein the interface unit is configured to receive one set of data relating to a screen by itself, and the control unit is further configured to select a pointer in the set of data to a further selectable screen and to cause the interface unit to transmit the pointer to the image capturing device.

17. A portable communication device according to claim 11, further comprising a number of user input units and a display, wherein the control unit is further configured to associate the command with at least one of the user input units, and to present the command on the display.

18. A portable communication device according to claim 11, wherein the control unit is further configured to combine captured image data received from the image capturing device with image data from a source other than the image capturing device.

19. A portable communication device according to claim 11, wherein the portable communication device comprises a mobile telephone.

20. A computer program product for controlling a remotely located image capturing device from a portable communication device, the computer program product comprising:
a computer readable storage medium having computer readable program code embodied in said medium, said computer readable program code comprising:
computer readable program code configured to receive MMI data and associated media data from the image capturing device including at least one set of screen data related to a screen intended for presentation on a display of the portable communication device and comprising a selectable command related to the screen;
computer readable program code configured to select the command; and
computer readable program code configured to cause the command to be sent to the image capturing device.

21. The computer program product of claim 20, further comprising:
computer readable program code configured to receive at least one image captured by the image capturing device; and
computer readable program code configured to store the at least one image in the portable communication device.

22. A method of operating an image capturing device to enable the image capturing device to be remotely controlled by a portable electronic device, the method comprising:
sending MMI data from the image capturing device to the portable communication device, the MMI data including at least one set of screen data related to at least one screen intended for presentation on a display of the portable communication device, the MMI data including selectable commands related to the screen, format information specifying the format in which the commands are to be transferred, and/or a pointer to a further selectable screen, wherein one of the at least one screens is a media capturing screen;
sending media data intended to be presented together with the MMI data from the image capturing device to the portable communication device; and
receiving a command from the portable communication device.

23. A method according to claim 22 wherein the MMI data includes an image capturing command, the method further comprising:
sending at least one image captured by the image capturing device to the portable electronic device in response to receiving the image capturing command from the portable communication device.

24. A method according to claim 22, wherein the MMI data includes a command to browse images stored in the image capturing device, the method further comprising:
sending at least one image stored in the image capturing device to the portable electronic device in response to receiving the command to browse images from the portable communication device.

25. A method according to claim 22, wherein the MMI data includes a control command for adjusting the image capturing device, the method further comprising:
adjusting the image capturing device in accordance with the control command in response to receiving the control command from the portable communication device.

26. An image capturing device, comprising:
an interface unit configured to send MMI data and associated media data from the image capturing device to the portable communication device, the MMI data including at least one set of screen data related to at least one screen intended for presentation on a display of the portable communication device, the MMI data including selectable commands related to the screen, format information specifying the format in which the commands are to be transferred, and/or a pointer to a further selectable screen, wherein one of the at least one screens is a media capturing screen; and
a control unit configured to cause the interface unit to send at least one image captured by the image capturing device in response to a command from the portable communication device.

27. An image capturing device according to claim 26, wherein one of the at least one screens is a browsing screen, and wherein the control unit is further configured to cause at least one image stored in the image capturing device to be sent to the portable electronic device in response to a command to browse images received from the portable electronic device.

28. An image capturing device according to claim 26, wherein the control unit is further configured to adjust the image capturing device according to a control command for adjusting the image capturing device.

29. A computer program product for enabling a portable communication device to control a remotely located image capturing device, the computer program product comprising:
a computer readable storage medium having computer readable program code embodied in said medium, said computer readable program code comprising:
computer readable program code configured to send MMI data from the image capturing device to the portable communication device, the MMI data including at least one set of screen data related to at least one screen intended for presentation on a display of the portable communication device, the MMI data including selectable commands related to the screen, format information specifying the format in which the commands are to be transferred, and/or a pointer to a further selectable screen, wherein one of the at least one screens is a media capturing screen;
computer readable program code configured to send media data intended to be presented together with the MMI data from the image capturing device to the portable communication device; and
computer readable program code configured to receiving a command from the portable communication device.
